(19) United States
(12) Patent Application Publication
(10) Pub. No.: US 2024/0070477 A1
(43) Pub. Date: Feb. 29, 2024

(54) SERVER DEVICE

(71) Applicant: NEC Corporation, Tokyo (JP)

(72) Inventors: Junki Mori, Tokyo (JP); Isamu Teranishi, Tokyo (JP); Batnyam Enkhtaivan, Tokyo (JP)

(73) Assignee: NEC Corporation, Tokyo (JP)

(21) Appl. No.: 18/237,200

(22) Filed: Aug. 23, 2023

(30) Foreign Application Priority Data
Aug. 30, 2022 (JP) 2022-137348

(51) Int. Cl. G06N 5/01

(52) U.S. Cl. CPC G06N 5/01

(57) ABSTRACT

A server device includes an acquisition unit that acquires, from each of a plurality of client devices, information representing a value of a node constituting a decision tree, the information being determined based on the learning data held by the own device of each client device, and a determination unit that determines the value of the node constituting the decision tree by integrating the acquired results. The decision tree is learned by determination of the value of each node constituting the decision tree by the determination unit.

### INCORPORATION BY REFERENCE

The present invention is based upon and claims the benefit of priority from Japanese patent application No. 2022-137348, filed on Aug. 30, 2022, the disclosure of which is incorporated herein in its entirety by reference.

### TECHNICAL FIELD

The present invention relates to a server device, a learning method, a storage medium, and a client device.

### BACKGROUND ART

As a machine learning model having high accuracy and small computation quantity with respect to tabular format data and the like, a Gradient Boosting Decision Tree (GBDT) has been known.

As a literature about GBDT, for example, Patent Literature 1 has been known. Patent Literature 1 describes a learning device for learning using gradient boosting. For example, a learning device includes a data storage unit that stores therein learning data and gradient information to learn a model; a learning unit that learns the model; an update unit that updates the gradient information; a sub-sampling unit that determines whether or not to use the learning data to learn the next model based on a sub-sampling rate; a first buffer unit for buffering the learning data and the gradient information, determined to be used, up to a predetermined capacity; and a second buffer unit for buffering the learning data and the gradient information, determined not to be used, up to a predetermined capacity. When buffering the learning data and the gradient information up to a predetermined capacity, the first buffer unit and the second buffer unit write to the data storage unit for each given block. According to Patent Literature 1, with the above-described configuration, it is possible to perform data sampling on a large amount of sample data in gradient boosting.
Patent Literature 1: JP 2021-015523 A

### SUMMARY

As one type of federated learning for performing training of a machine learning model through cooperation by a plurality of clients without direct exchange of learning data, horizontal federated learning has been known. In horizontal federated learning, training is performed by using feature values shared by the clients. In the case of performing such horizontal federated learning for GBDT, by mutually transmitting gradient information as described in Patent Literature 1 while encrypting it, a threshold and a feature value of each node constituting the decision tree may be learned in a cooperative manner.

In the case of mutually transmitting gradient information by encrypting it as described above, the computation quantity is enormous since encrypting is required. Moreover, since it is necessary to communicate gradient information many times for determining a feature value and a threshold of each node, the communication amount is also increased. This causes a problem that it is difficult to perform horizontal federated learning efficiently.

In view of the above, an exemplary object of the present invention is to provide a server device, a learning method, a storage medium, and a client device that solve the above-described problem.

In order to achieve such an object, a server device according to one aspect of the present disclosure is configured to include
an acquisition unit that acquires, from each of a plurality of client devices, information representing a value of a node constituting a decision tree, the information being determined based on learning data held by the own device of each of the client devices, and
a determination unit that determines a value of the node constituting the decision tree by integrating the acquired results.

The decision tree is learned by determination of the value of each node constituting the decision tree by the determination unit.

Further, a learning method according to another aspect of the present disclosure is configured to include, by an information processing device,
acquiring, from each of a plurality of client devices, information representing a value of a node constituting a decision tree, the information being determined based on the learning data held by the own device of each of the client devices;
determining a value of the node constituting the decision tree by integrating the acquired results, and
learning the decision tree by determining the value of each node constituting the decision tree.

Further, a storage medium according to another aspect of the present disclosure is a computer-readable medium storing thereon a program for causing an information processing device to execute processing to
acquire, from each of a plurality of client devices, information representing a value of a node constituting a decision tree, the information being determined based on the learning data held by the own device of each of the client devices;
determine a value of the node constituting the decision tree by integrating the acquired results, and
learn the decision tree by determining the value of each node constituting the decision tree.

Further, a client device according to another aspect of the present invention is configured to include
a calculation unit that determines a value of a node constituting a decision tree on the basis of the learning data held by the own device; and
a transmission unit that transmits the value of the node calculated by the calculation unit to a server device.

With the configurations described above, the problem described above can be solved.

### BRIEF DESCRIPTION OF DRAWINGS

FIG. 1 illustrates the outline of a learning system according to a first example embodiment of the present disclosure.

FIG. 2 illustrates horizontal federated learning.

FIG. 3 illustrates an exemplary configuration of a learning system.

FIG. 4 is a block diagram illustrating an exemplary configuration of a server device.

FIG. 5 illustrates an example of received information.

FIG. 6 is a block diagram illustrating an exemplary configuration of a client device.

FIG. 7 is a flowchart illustrating an exemplary operation of a server device.

FIG. 8 is a flowchart illustrating an exemplary operation of a client device.

FIG. 9 illustrates an exemplary hardware configuration of a server device according to a second example embodiment of the present disclosure.

FIG. 10 is a block diagram illustrating an exemplary configuration of a server device.

FIG. 11 is a block diagram illustrating an exemplary configuration of a client device.

### EXAMPLE EMBODIMENTS

### First Example Embodiment

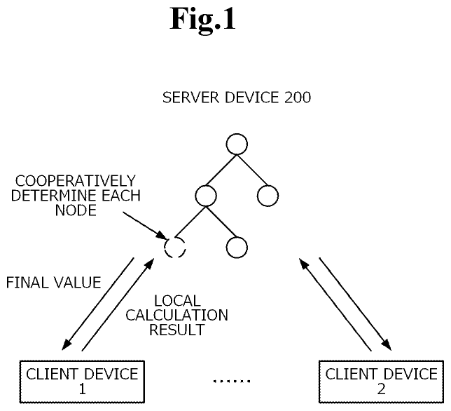

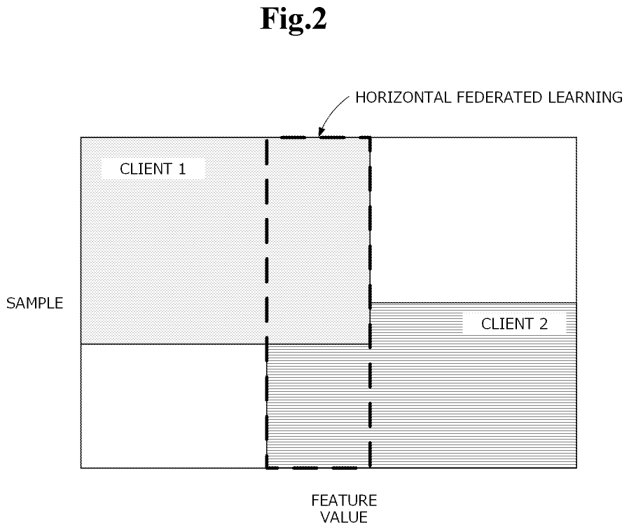

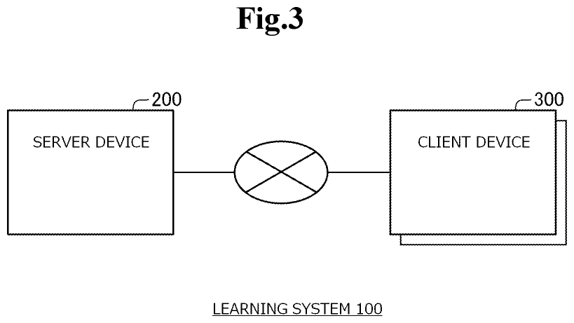

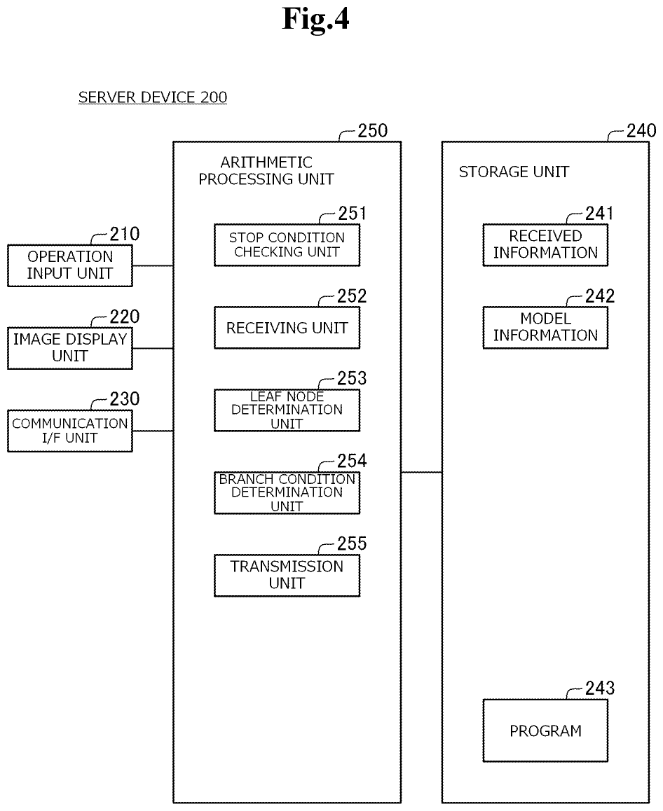

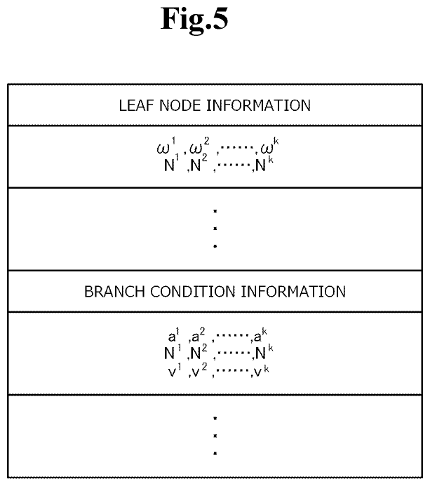

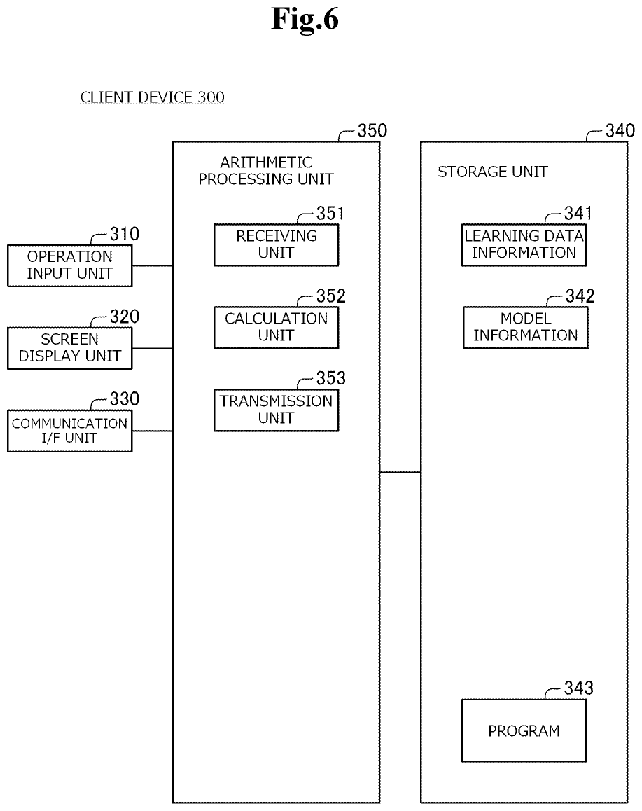

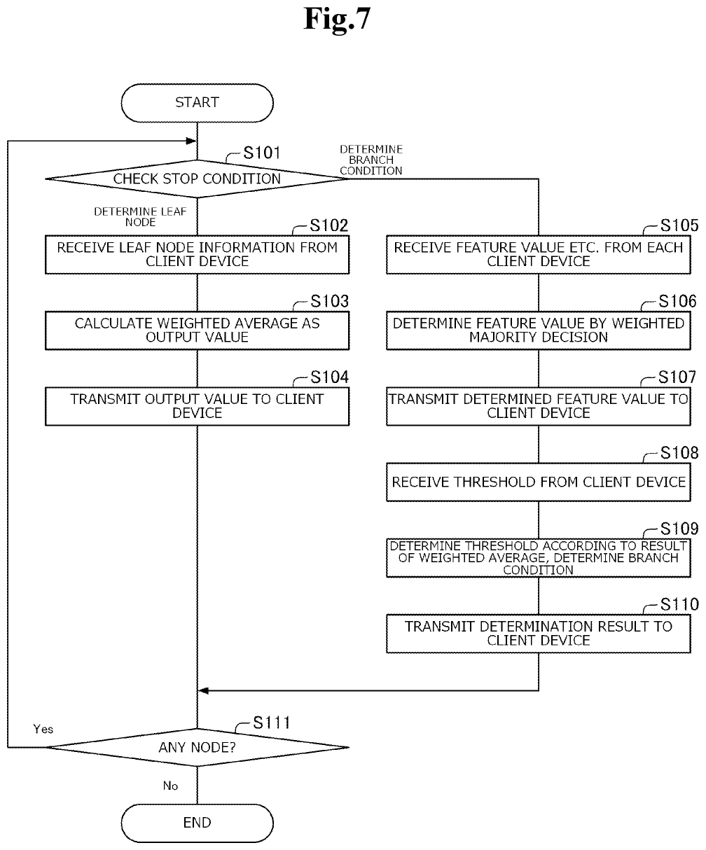

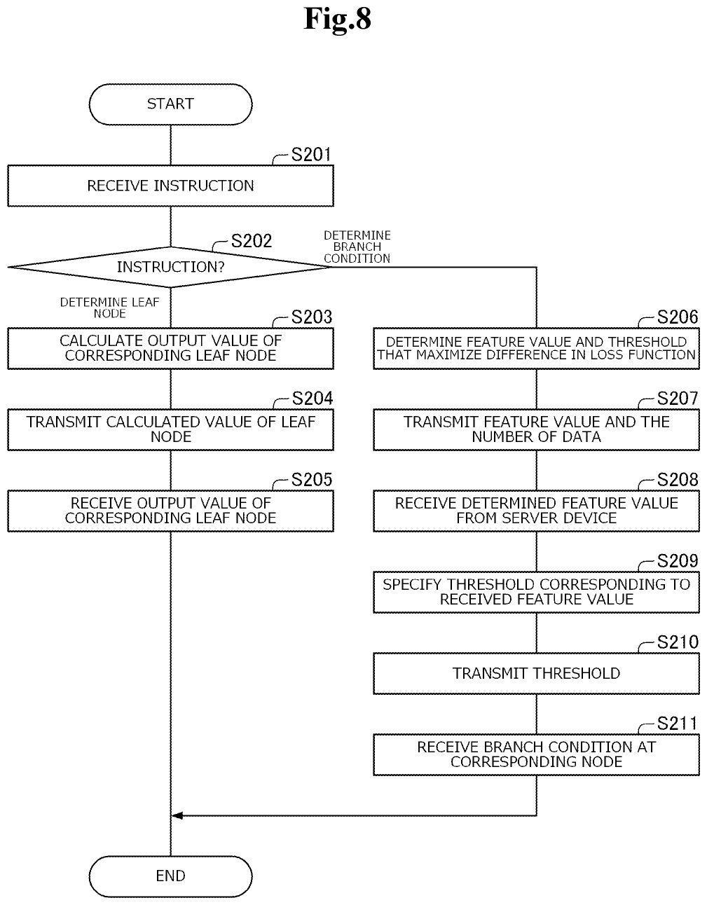

A first example embodiment of the present disclosure will be described with reference to FIGS. 1 to 8. FIG. 1 illustrates the outline of a learning system 100. FIG. 2 illustrates horizontal federated learning. FIG. 3 illustrates an exemplary configuration of the learning system 100. FIG. 4 is a block diagram illustrating an exemplary configuration of a server device 200. FIG. 5 illustrates an example of received information 241. FIG. 6 is a block diagram illustrating an exemplary configuration of a client device 300. FIG. 7 is a flowchart illustrating an exemplary operation of the server device 200. FIG. 8 is a flowchart illustrating an exemplary operation of the client device 300.

A first example embodiment of the present disclosure describes a learning system 100 in which a plurality of client devices 300 and a server device 200 perform federated learning in corporation with each other. As illustrated in FIG. 1, in the learning system 100, each client device 300 independently performs calculation for determining a node by using the own data, and transmits the calculation result to the server device 200. Then, the server device 200 integrates the results independently calculated by the respective client devices 300 to determine the value of a node in the global model constituting the decision tree that is a learning model. For example, the learning system 100 determines the value of a node according to a result of transmitting, to the server device 200, the results of calculation independently performed by the respective client devices 300, rather than gradient information, as described above. The learning system 100 can determine the value of each node by performing the processing as described above on each node constituting the decision tree.

Moreover, by checking a predetermined stop condition in the global model, the server device 200 can decide which of a leaf node that is a terminal node constituting the decision tree and an internal node other than the leaf node, the node whose value is to be determined is. Then, the server device 200 can acquire the value of the node corresponding to the decision result from each client device 300. For example, in the case where the node whose value is to be determined is a leaf node, the server device 200 acquires, from each client device 300, information including an output value of the leaf node independently calculated by each client device 300. On the other hand, in the case where the node whose value is to be determined is an internal node, the server device 200 acquires, from each client device 300, a value corresponding to the branch condition at the internal node independently calculated by each client device 300. As described above, the server device 200 can acquire information corresponding to the decision result about the node whose value is to be determined, from each client device 300, for example. Note that the stop condition may be a known one such as the depth of the node determined in the global model or the number of pieces of allocated learning data.

In the learning system 100 described in the present embodiment, each client device 300 and the server device 200 can share the model structure. For example, each client device 300 and the server device 200 can share information about a node for which determination is currently made, the overall structure of the determination tree, and the like. Sharing of the information as described above may be realized by transmitting the decision result as described above to each client device 300. It is also possible to have another configuration for sharing such information between each client device 300 and the server device 200.

In the present embodiment, as illustrated in FIG. 2, the case of performing horizontal federated learning that is learning based on common feature values in the respective client devices 300, of the federated learning, will be described as an example. For example, in the example of FIG. 2, in a client 1 and a client 2 that are client devices 300, respective samples have a common feature value. For example, the horizontal federated learning can be performed in the case where there are a plurality of client devices 300 handling the same feature value although samples such as customers are different, such as the case where two regional banks have different customers for different regions. By performing horizontal federated learning in such a situation, it is possible to perform learning using samples not held by the own device, as compared with the case where a single client device 300 such as the client 1 performs learning independently. As a result, it is possible to perform learning based on a larger amount of data.

Moreover, in the present embodiment, the case of performing federated learning on the Gradient Boosting Decision Tree (GBDT) for generating a model in which a plurality of trees are added, in the learning system 100. For example, in the gradient boosting decision tree, when learning the t^{th} tree, learning of the new tree can be performed by filling the gap between the sum of outputs up to the t-lth tree and a label that is an objective variable.

As an example, in the gradient boosting decision tree, in the case of determining a branch condition at an internal node, a difference Lₛₚₗᵢₜ in a loss function is calculated by using an expression such as Expression 1, with respect to each threshold of each feature value. Then, in the gradient boosting decision tree, a feature value and a threshold in which the difference Lₛₚₗᵢₜ in the loss function becomes the largest can be adopted as a branch condition.

$$[ Expression 1 ]$$

$${ℒ}_{split} = \frac{1}{2} [ \frac{{( {\sum }_{i ∈ {I}_{L}} {g}_{i} )}^{2}}{{\sum }_{i ∈ {I}_{L}} {h}_{i} + λ} + \frac{{( {\sum }_{i ∈ {I}_{R}} {g}_{i} )}^{2}}{{\sum }_{i ∈ {I}_{R}} {h}_{i} + λ} - \frac{{( {\sum }_{i ∈ I} {g}_{i} )}^{2}}{{\sum }_{i ∈ I} {h}_{i} + λ} ] - γ$$

Note that gᵢ and hᵢ represent numbers called gradient information. Further, I_{L} represents learning data that proceeds to a left-side node after the division, and I_{R} represents learning data that proceeds to a right-side node after the division. Further, I represents learning data present on the node before the division. As described above, in Expression 1, the difference in the loss function before and after the division is calculated.

Moreover, in the gradient boosting decision tree, when determining an output value of a leaf node, the output value can be determined using an expression such as Expression 2.

$$[ Expression 2 ]$$

$${w}_{j}^{*} = - \frac{{\sum }_{i ∈ {I}_{j}} {g}_{i}}{{\sum }_{i ∈ {I}_{j}} {h}_{i} + λ}$$

Note that gᵢ and hᵢ represent numbers called gradient information, as similar to Expression 1.

Hereinafter, the configuration of the learning system 100 will be described in more detail. FIG. 3 illustrates an exemplary configuration of the learning system 100. Referring to FIG. 3, for example, the learning system 100 includes a plurality of client devices 300 and the server device 200. As illustrated in FIG. 3, the client devices 300 and the server device 200 are connected communicably with each other over a network or the like, for example. Note that the learning system 100 may have any number (two or more) of client devices 300.

The server device 200 is an information processing device that integrates the results received from the respective client devices 300 to determine the value of a node in the global model constituting the decision tree. The server device 200 can determine the value of each node by performing the integration process for each node. FIG. 4 illustrates an exemplary configuration of the server device 200. Referring to FIG. 4, the server device 200 includes an operation input unit 210, a screen display unit 220, a communication interface (I/F) unit 230, a storage unit 240, and an arithmetic processing unit 250, for example, as main constituent elements.

FIG. 4 illustrates the case of implementing the function of the server device 200 using one information processing device, as an example. However, the server device 200 may be implemented using a plurality of information processing devices such as implemented on the cloud, for example. Moreover, the server device 200 may not include part of the above-mentioned constituent elements such as not including the operation input unit 210 or the screen display unit 220, or may include a constituent element other than those described above.

The operation input unit 210 is configured of operation input devices such as a keyboard and a mouse. The operation input unit 210 detects operation by an operator who operates the server device 200, and outputs it to the arithmetic processing unit 250.

The screen display unit 220 is a screen display device such as a liquid crystal display (LCD). The screen display unit 220 can display, on the screen, various types of information stored in the storage unit 240, in response to an instruction from the arithmetic processing unit 250.

The communication I/F unit 230 is configured of a data communication circuit. The communication I/F unit 230 performs data communication with external devices such as the client devices 300 connected over a communication network.

The storage unit 240 is a storage device such as a hard disk drive (HDD), a solid state drive (SSD), or a memory. The storage unit 240 stores therein processing information and a program 243 required for various types of processing performed in the arithmetic processing unit 250. The program 243 is read and executed by the arithmetic processing unit 250 to thereby implement various processing units. The program 243 is read in advance from an external device or a storage medium via a data input/output function of the communication I/F unit 230 and the like, and is stored in the storage unit 240. The main information stored in the storage unit 240 includes, for example, received information 241, model information 242, and the like.

The received information 241 includes information received from each of the client devices 300. For example, the received information 241 is updated in response to receiving, from each client device 300 by the receiving unit 252, of information representing the value of a node or the like independently calculated by each client device 300.

FIG. 5 illustrates an example of the received information 241. Referring to FIG. 5, the received information 241 may include leaf node information indicating an output value of a leaf node independently calculated by each client device 300, branch condition information indicating a value corresponding to the branch condition at an internal node independently calculated by each client device 300, and the like.

The leaf node information includes information required for determining an output value of a leaf node in the server device 200. As an example, the leaf node information includes, for each client device 300, values such as an output value w of a leaf node independently calculated by each client device 300, and the learning data number N that is the number of pieces of learning data assigned to the leaf node in the client device 300. For example, FIG. 5 illustrates the case where the learning system 100 includes k units of client devices 300 as an example. Therefore, the leaf node information includes k pieces of output values co and k pieces of learning data number N. The number of client devices 300 held by the learning system 100 is arbitrary as described above.

Note that the leaf node information may include information indicating the output value co calculated by each client device 300, for each leaf node constituting the decision tree. For example, in the leaf node information, identification information for identifying the leaf node and information indicating the output value co calculated by each client device 300 may be associated with each other.

The branch condition information includes information required for determining a value corresponding to the branch condition at the internal node in the server device 200. As an example, the branch condition information includes, for each client device 300, values such as a feature value “a” that maximizes the difference in the loss function, the learning data number N that is the number of pieces of learning data assigned to the internal node, and a threshold v that are independently calculated by the client device 300. For example, FIG. 5 illustrates the case where the learning system 100 includes k units if client devices 300 as an example. Therefore, the branch condition information includes k pieces of feature values “a” and the like. The number of client devices 300 held by the learning system 100 is arbitrary, as described above.

Note that the branch condition information may include information representing a value corresponding to the branch condition calculated by each client device 300, for each internal node constituting the decision tree. For example, in the branch condition information, identification information for identifying an internal node and information representing a value corresponding to the branch condition calculated by each client device 300 may be associated with each other. Moreover, the server device 200 can determine the branch condition using either one of the methods to be described below. The information included in the branch condition information may be one corresponding to the method used for determining the branch condition by the server device 200. For example, the branch condition information may include information indicating the difference in the loss function for each feature value and information indicating the threshold v for each feature value, in addition to or instead of various values described above as examples. The branch condition information may include information corresponding to the method used for determining the branch condition by the server device 200, other than those described above as examples.

The model information 242 includes information about the decision tree that is a learning model learned by the server device 200. For example, the model information 242 includes a value of a node in the global model determined by integrating the local calculation results received from the respective client devices 300. As an example, the model information 242 includes information indicating a value corresponding to the global model such as a value representing the branch condition at an internal node constituting the decision tree and an output value of a leaf node. For example, the model information 242 is updated in response to determination of the values of the leaf node and the internal node by the leaf node determination unit 253 and the branch condition determination unit 254.

The arithmetic processing unit 250 includes an arithmetic unit such as a central processing unit (CPU) and the peripheral circuits. The arithmetic processing unit 250 reads, from the storage unit 240, and executes the program 243 to implement various processing units through cooperation between the hardware and the program 243. Main processing unit implemented by the arithmetic processing unit 250 include, for example, a stop condition checking unit 251, a receiving unit 252, a leaf node determination unit 253, a branch condition determination unit 254, and a transmission unit 255.

Note that the arithmetic processing unit 250 may include a Graphic Processing Unit (GPU), a Digital Signal Processor (DSP), an Micro Processing Unit (MPU), an Floating point number Processing Unit (FPU), a Physics Processing Unit (PPU), a Tensor Processing Unit (TPU), a quantum processor, a microcontroller, or a combination thereof, instead of the CPU.

The stop condition checking unit 251 checks the predetermined stop condition to decide which of a leaf node and an internal node the determination object node is. The stop condition checking unit 251 may perform the decision using a condition similar to the existing condition used for deciding the node type in the gradient boosting decision tree or the like.

For example, the stop condition checking unit 251 refers to the model information 242 and the like to check whether the determined decision tree and the node satisfy an arbitrary condition corresponding to the depth (passage length) of the determined node, the number of pieces of assigned learning data, and the like. As an example, the stop condition checking unit 251 decides that the determination object node is an internal node when the depth of the determined node is less than a given value. Moreover, the stop condition checking unit 251 decides that the determination object node is a leaf node when the depth of the determined node is equal to or a larger than a given value. As described above, the stop condition checking unit 251 may perform the decision using another known condition or a combination of known conditions.

Note that the stop condition checking unit 251 may be configured to transmit the decision result to each client device 300. With such a configuration, the stop condition checking unit 251 can appropriately acquire information corresponding to the decision result from each client device 300.

The receiving unit 252 receives the value of a node independently calculated by each client device 300, from the client device 300 via the communication I/F unit 230. For example, the receiving unit 252 receives, from each client device 300, information corresponding to the result of decision by the stop condition checking unit 251 such as a value corresponding to an output value of a leaf node or a branch condition at an internal node. Moreover, the receiving unit 252 stores the received information in the storage unit 240 as the received information 241.

Note that the receiving unit 252 may receive various types of information in an aspect corresponding to the method to be used for determining the branch condition by the branch condition determination unit 254 to be described below. For example, the receiving unit 252 receives, from the client device 300, a feature value and the number of pieces of learning data that maximize the difference in the loss function in the client device 300. Then, the receiving unit 252 receives, from the client device 300, a threshold calculated by the client device 300 according to the feature value determined by the branch condition determination unit 254. As described above, the receiving unit 252 may receive the information corresponding to the method to be used for determining the branch condition by the branch condition determination unit 254 in the sequence corresponding to the method.

The leaf node determination unit 253 determines the value of a leaf node that is a determination object in the global model by integrating the output values of the leaf node independently calculated by the respective client devices 300, received from the respective client devices 300. Moreover, the leaf node determination unit 253 stores the determined value in the model information 242.

For example, the leaf node determination unit 253 refers to the leaf node information included in the received information 241 to specify the output value of the leaf node independently calculated by each client devices 300 and the number of pieces of learning data assigned to the leaf node. Then, the leaf node determination unit 253 calculates a weighted average in which weighting is performed on the specified output values, corresponding to the number of pieces of learning data assigned to the leaf node in the client device 300, to thereby determine the value of the node.

Specifically, for example, the leaf node determination unit 253 performs calculation according to Expression 3 to integrate the output values calculated by the respective client devices 300 to thereby determine the output value of the leaf node that is a determination object.

ωⱼ*=ΣₖNⱼ^{k}ωⱼ^{k}/ΣₖNⱼ^{k} [Expression 3]

Note that N represents the number of pieces of learning data, and ω represents an output value. Moreover, k corresponds to the client device 300. For example, N^{k} represents the number of pieces of learning data received from a client device 300-k. Furthermore, j represents information for identifying the leaf node.

The branch condition determination unit 254 determines the value of the internal node that is a determination object in the global model by integrating the values or the like corresponding to the branch condition received from the respective client devices 300. Moreover, the branch condition determination unit 254 stores the determined value in the model information 242.

As an example, after determining the feature value based on the information received from the respective client devices 300, the branch condition determination unit 254 determines a threshold based on the thresholds calculated by the respective client devices 300 based on the determined feature value to thereby determine the branch condition consisting of the feature value and the threshold. For example, the branch condition determination unit 254 refers to the branch condition information included in the received information 241 to specify the feature value and the number of pieces of learning data that maximize the difference in the loss function, independently calculated by the respective client devices 300. Then, the branch condition determination unit 254 performs weighted majority decision in which weighting is performed on the number of the specified feature values or the like, corresponding to the number of pieces of learning data assigned to the internal node in the client device 300, to thereby determine the feature value at the global internal node. For example, the branch condition determination unit 254 aggregates the numbers received from the respective client devices 300 for each feature value. At that time, the branch condition determination unit 254 may perform aggregation after performing adjustment by weighting according to the number of pieces of learning data. Then, based on the result of aggregation, the branch condition determination unit 254 can determine the value of a feature value that has been received the most, to be the feature value at the global internal node. Note that the weighting state according to the number of pieces of learning data may be adjusted arbitrarily. Moreover, after the receiving unit 252 receives the threshold calculated by each client device 300 based on the determined feature value from each client device 300, the branch condition determination unit 254 determines the value of the node by calculating a weighted average in which weighting is performed corresponding to the number of pieces of learning data assigned to the internal node in the client device 300, with respect to the received thresholds. Specifically, for example, the branch condition determination unit 254 performs calculation according to Expression 4 to integrate the thresholds independently calculated by the respective client devices 300, to thereby determine the threshold of the internal node that is a determination object.

v*=ΣₖN^{k}v^{k}/ΣₖN^{k} [Expression 4]

Note that N represents the number of pieces of learning data, and v represents a threshold. Moreover, k corresponds to the client device 300. For example, N^{k} represents the number of pieces of learning data received from a client device 300-k.

Instead of the method of receiving the feature value from each client device 300 as described above as an example, the branch condition determination unit 254 may be configured to receive the difference in the loss function for each feature value from each client device 300 to thereby determine the feature value based on the received difference in the loss function. In the case of using such a method, for example, the receiving unit 252 receives, from each client device 300, the difference in the loss function when each client device 300 independently determines the threshold that maximizes the difference in the loss function with respect to each feature value. That is, the receiving unit 252 receives the difference in the loss function for each feature value and the number of pieces of learning data. In response to it, the branch condition determination unit 254 calculates the weighted average as indicated by Expression 5 with respect to each feature value “a” to determine the feature value that maximizes the calculation result to be the feature value of the internal node that is a determination object. In the case of such a method, the process after the determination of the feature value may be similar to that in the above-described example.

Lₛₚₗᵢₜ^{a}=ΣₖN^{k}Lₛₚᵢₗₜ^{k,a}/ΣₖN^{k} [Expression 5]

Note that N represents the number of pieces of learning data, and Lₛₚₗᵢₜ represents the difference in the loss function. Moreover, “k” correspond to the client device 300, and “a” represents a feature value.

Instead of the above-described method, the branch condition determination unit 254 may receive thresholds for each feature value from the respective client devices 300 and determine the threshold of the global internal node based on the received thresholds. That is, the branch condition determination unit 254 may be configured to determine the threshold before determining the feature value. Moreover, the branch condition determination unit 254 may determine the feature value based on the difference in the loss function for each feature value when using the determined threshold that is calculated by the respective client devices 300 based on the determined threshold. In the case of using such a method, for example, the receiving unit 252 receives, from each client device 300, a threshold when each client device 300 independently determines a threshold that maximizes the difference in the loss function with respect to each feature value. That is, the receiving unit 252 receives a threshold for each feature value and the number of pieces of learning data. In response to it, the branch condition determination unit 254 can determine the threshold for each feature value by calculating the weighted average of the thresholds as indicated by Expression 6 with respect to each feature value “a”.

vₐ=ΣₖN^{k}vₐ^{k}/ΣₖN^{k} [Expression 6]

Note that N represents the number of pieces of learning data, and v represents a threshold. Moreover, k corresponds to the client device 300. For example, N^{k} represents the number of pieces of learning data received from a client device 300-k. “a” corresponding to a feature value.

Moreover, after the receiving unit 252 receives, from each client device 300, the difference in the loss function for each feature value calculated by each client device 300 based on the determined threshold, the branch condition determination unit 254 determines a feature value in which the difference in the loss function becomes maximum in response to the result of calculating the weighted average according to Expression 7 with respect to each feature value. Thereby, the branch condition determination unit 254 can determine the feature value and the threshold corresponding to the feature value as a branch condition.

Lₛₚₗᵢₜ^{a}=ΣₖN^{k}Lₛₚₗᵢₜ^{k,a}/Σₖ [Expression 7]

Note that N represents the number of pieces of learning data, and Lₛₚₗᵢₜ represents the difference in the loss function. Moreover, “k” correspond to the client device 300, and “a” represents a feature value.

The branch condition determination unit 254 can determine the value of the global internal node that is a determination object by integrating the values corresponding to the branch condition received from the respective client devices 300 using any of the above-described methods. Note that the method to be used for determining the branch condition by the branch condition determination unit 254 is shared with the respective client devices 300 in advance. It is also possible to have a configuration in which after the branch condition determination unit 254 determines the branch condition, the stop condition checking unit 251 decides the next node.

The transmission unit 255 transmits the values and the like determined by the leaf node determination unit 253 and the branch condition determination unit 254 to each client device 300. After transmitting the feature value according to the determination of the feature value by the branch condition determination unit 254, the transmission unit 255 may transmit a value in response to the determination by the branch condition determination unit 254 to each client device 300 at the timing of determining the branch condition by the branch condition determination unit 254, such as transmitting the threshold in response to the determination of the threshold by the branch condition determination unit 254.

The exemplary configuration of the server device 200 is as described above. Next, an exemplary configuration of the client device 300 will be described with reference to FIG. 6. The client device 300 is an information processing device that independently calculates the value of a local node using learning data held by itself. The client device 300 can receive, from the server device 200, the value of a global node determined by the server device 200. FIG. 6 illustrates an exemplary configuration of the client device 300. Referring to FIG. 6, the client device 300 includes, for example, an operation input unit 310, a screen display unit 320, a communication I/F unit 330, a storage unit 340, and an arithmetic processing unit 350, as main constituent elements. The client device 300 may be implemented using a plurality of information processing devices such as implemented on the cloud, as similar to the server device 200. Moreover, the client device 300 may not include part of the above-mentioned constituent elements such as not including the operation input unit 310 or the screen display unit 320, or may include a constituent element other than those described above.

The configurations of the operation input unit 310, the screen display unit 320, and the communication I/F unit 330 may be the same as those of the server device 200. Therefore, the description thereof is omitted.

The storage unit 340 is a storage device such as an HDD, an SSD, or a memory. The storage unit 340 stores therein processing information and a program 343 required for various types of processing performed in the arithmetic processing unit 350. The program 343 is read and executed by the arithmetic processing unit 350 to thereby implement various processing units. The program 343 is read in advance from an external device or a storage medium via the data input/output function of the communication OF unit 330 and the like, and is stored in the storage unit 340. The main information stored in the storage unit 340 includes, for example, learning data information 341, model information 342, and the like.

The learning data information 341 includes learning data used for calculation by the calculation unit 352 to be described below. For example, the learning data information 341 is acquired in advance by using a method of acquiring it from an external device via the communication OF unit 330 or inputting it using the operation input unit 310, and is stored in the storage unit 340. For example, the learning data information 341 includes a feature value that is common to the respective client devices 300 although the samples are different.

The model information 342 includes the value of a node in a local model independently calculated using the learning data included in the learning data information 341. The model information 342 may also include, for example, a value of a node in a global model received from the server device 200. For example, the model information 342 is updated corresponding to independent calculation by the calculation unit 352 to be described below based on the learning data included in the learning data information 341, or the like. The model information 342 may also be updated corresponding to receiving of a value of a global node by the receiving unit 351 from the server device 200, or the like.

The arithmetic processing unit 350 includes an arithmetic unit such as a CPU and its peripheral circuits. The arithmetic processing unit 350 reads, from the storage unit 340, and executes the program 343 to implement various processing units through cooperation between the hardware and the program 343. Main processing units to be implemented by the arithmetic processing unit 350 include, for example, the receiving unit 351, the calculation unit 352, and the transmission unit 353. Note that the arithmetic processing unit 350 may include a GPU or the like in place of the CPU, as similar to the case of the server device 200.

The receiving unit 351 receives a value of a node in a global model determined by the server device 200, from the server device 200. Moreover, the receiving unit 351 can store the received value in the storage unit 340 as the model information 342.

The receiving unit 351 can also receive, from the server device 200, information indicating the result of deciding which of a leaf node and an internal node the node to be calculated next is. Note that which of a leaf node and an internal node the node to be calculated next is may be decided by the client device 300.

The calculation unit 352 calculates the value of each node constituting the decision tree based on the learning data included in the learning data information 341. The calculation unit 352 may calculate either an output value or a branch condition corresponding to the decision result by the server device 200 received by the receiving unit 351.

For example, the calculation unit 352 can independently determine a feature value or a threshold by calculating the difference in the loss function using above-described Expression 1 or the like, based on the learning data included in the learning data information 341. In that case, the calculation unit 352 may determine the value by a method corresponding to the method to be used for determining the branch condition by the branch condition determination unit 254 of the server device 200. As an example, the calculation unit 352 can independently determine a feature value and a threshold that maximize the difference in the loss function by calculating the difference in the loss function with respect to each threshold of each feature value, based on the learning data included in the learning data information 341. Moreover, the calculation unit 352 can calculate an optimum threshold to the feature value received from the server device 200, by the same method. The calculation unit 352 may determine the threshold corresponding to the feature value received from the server device 200 by storing the relationship between the feature value and the threshold of the time of independently determining the feature value and the threshold that maximize the difference in the loss function.

The calculation unit 352 can also calculate the output value of a leaf node by using above-described Expression 2 or the like, based on the learning data included in the learning data information 341.

The transmission unit 353 transmits the value calculated and determined by the calculation unit 352, to the server device 200. For example, the transmission unit 353 can transmit the independently calculated value of a node in the local model to the server device 200, in response to calculation and determination by the calculation unit 352.

The exemplary configuration of the client device 300 is as described above. Next, an exemplary operation of the server device 200 and the client device 300 will be described with reference to FIGS. 7 to 10. First, an exemplary operation of the server device 200 will be described with reference to FIG. 7.

FIG. 7 is a flowchart illustrating an exemplary operation of the server device 200. Referring to FIG. 7, the stop condition checking unit 251 checks the predetermined stop condition to decide which of a leaf node and an internal node the determination object node is (step S101).

When the stop condition checking unit 251 decides that the determination object node is a leaf node (step S101, determine leaf node), the receiving unit 252 receives, from each client device 300, information indicating the output value of the leaf node that is independently calculated by each client device 300 and the number of pieces of learning data (step S102).

The leaf node determination unit 253 calculates a weighted average in which weighting is performed on the plurality of output values received from the respective client devices 300 corresponding to the number of pieces of learning data, to thereby determine the value of the node (step S103).

The transmission unit 255 transmits, to each client device 300, the output value of the leaf node in the global model determined by the leaf node determination unit 253 (step S104).

On the other hand, when the stop condition checking unit 251 decides that the determination object node is an internal node (step S101, determine branch condition), the receiving unit 252 receives, from each client device 300, the feature value that maximizes the difference in the loss function, independently calculated by each client device 300, and the number of pieces of learning data (step S105).

Then, the branch condition determination unit 254 performs weighted majority decision in which weighting is performed on the number of received pieces of learning data aggregated for each feature value, corresponding to the number of pieces of learning data, to thereby determine the feature value at the global internal node (step S106). In response to it, the transmission unit 255 transmits the feature value determined by the branch condition determination unit 254 to each client device 300 (step S107).

The receiving unit 252 receives, from each client device 300, a threshold calculated by the client device 300 based on the feature value transmitted from the transmission unit 255 (step S108).

The branch condition determination unit 254 calculates a weighted average in which weighting is performed on the received plurality of thresholds, corresponding to the number of pieces of learning data assigned to the internal node in the client device 300, to thereby determine the value of the node (step S109). In response to it, the transmission unit 255 transmits the feature value determined by the branch condition determination unit 254 to each client device 300 (step S110).

After the processing of step S104 or step S110, when a node that is a determination object exists (step S111, Yes), the stop condition checking unit 251 checks the predetermined stop condition to decide which of a leaf node and an internal node the determination object node is (step S101). Meanwhile, when no node exists (step S111, No), the server device 200 ends the processing.

The exemplary operation of the server device 200 is as described above. Next, an exemplary operation of the client device 300 will be described with reference to FIG. 8.

FIG. 8 is a flowchart illustrating an exemplary operation of the client device 300. Referring to FIG. 8, the receiving unit 351 receives, from the server device 200, information indicating the result of deciding which of a leaf node and an internal node the node to be calculated next is (step S201). Note that which of a leaf node and an internal node the node to be calculated next is may be decided by the client device 300.

In the case of receiving an instruction to determine a leaf node (step S202, determination of a leaf node), the calculation unit 352 calculates the output value of the leaf node by using above-described Expression 2 or the like, based on the learning data included in the learning data information 341. In response to it, the transmission unit 353 transmits the output value of the leaf node calculated by the calculation unit 352 and the number of pieces of learning data, to the server device 200 (step S204).

By using the output value of the leaf node transmitted from the transmission unit 353 and the like, the server device 200 determines the output value of the leaf node in the global model. Then, the receiving unit 351 receives the output value of the leaf node in the global model from the server device 200 (step S205).

On the other hand, in the case of receiving an instruction to determine a branch condition (step S202, determination of a branch condition), the calculation unit 352 calculates the difference in the loss function using above-described Expression 1 based on the learning data included in the learning data information 341 to thereby calculate the feature value and the threshold that maximize the difference in the loss function (step S206). In response to it, the transmission unit 353 transmits the feature value calculated by the calculation unit 352 and the number or pieces of learning data, to the server device 200 (step S207).

On the basis of the feature value transmitted by the transmission unit 353, the server device 200 determines the feature value at the internal node that is a determination object. Thereafter, the receiving unit 351 receives the feature value of the internal node determined by the server device 200 (step S208).

The calculation unit 352 calculates a threshold optimum to the feature value received by the receiving unit 351 (step S209). The calculation unit 352 may be configured to identify a threshold optimum to the feature value received by the receiving unit 351, by storing a combination of the feature value and the threshold calculated at step S206. The transmission unit 353 transmits the threshold calculated by the calculation unit 352, to the server device 200 (step S210).

On the basis of the threshold transmitted by the transmission unit 353, the server device 200 determines the threshold at the internal node that is a determination object. Thereafter, the receiving unit 351 receives the threshold of the internal node determined by the server device 200 (step S211). As a result, the client device 300 receives the value corresponding to the branch condition consisting of the feature value and the threshold.

The exemplary operation of the client device 300 is as described above.

As described above, the server device 200 includes the receiving unit 252, the leaf node determination unit 253, and the branch condition determination unit 254. With this configuration, the leaf node determination unit 253 can determine the output value of a leaf node in the global model on the basis of the output values of the leaf node and the like received by the receiving unit 252. Moreover, the branch condition determination unit 254 determines the value corresponding to the branch condition of an internal node in the global mode, on the basis of the values corresponding to the branch condition received by the receiving unit 252. As a result, it is possible to perform horizontal federated learning without transmitting gradient information, and to realize efficient learning.

The server device 200 also includes the stop condition checking unit 251. With this configuration, the receiving unit 252 can acquire information corresponding to the decision result by the stop condition checking unit 251 appropriately from each client device 300.

As described above, the branch condition determination unit 254 can determine the value of a global internal node that is a determination object by integrating the values corresponding to the branch condition received from the respective client devices 300 with use of any of a plurality of methods. Therefore, the processing from step S105 to step S110 illustrated in FIG. 7 may be processing corresponding to the method adopted by the branch condition determination unit 254.

### Second Example Embodiment

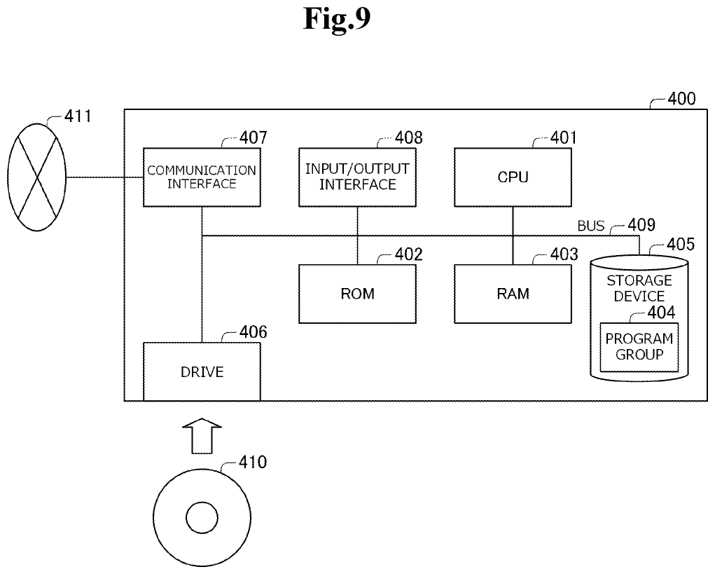

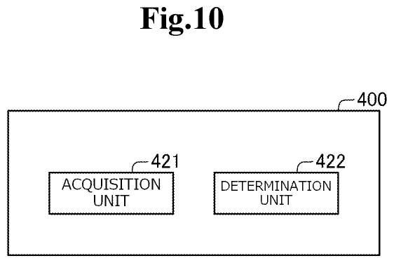

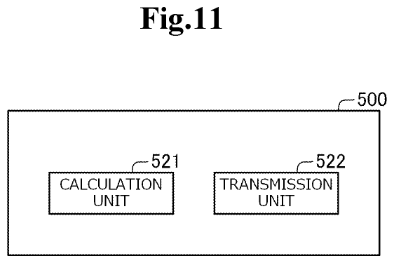

Next, a second example embodiment of the present disclosure will be described with reference to FIGS. 9 to 11. FIG. 9 is a diagram illustrating an exemplary hardware configuration of a server device 400. FIG. 10 is a block diagram illustrating an exemplary configuration of the server device 400. FIG. 11 is a block diagram illustrating an exemplary configuration of a client device 500.

The second example embodiment of the present disclosure describes exemplary configurations of the server device 400 that performs learning in corporation with the client device 500, and the client device 500. FIG. 9 illustrates an exemplary hardware configuration of the server device 400. Referring to FIG. 9, the server device 400 has a hardware configuration as described below, as an example.
Central Processing Unit (CPU) 401 (arithmetic device)
Read Only Memory (ROM) 402 (storage device)
Random Access Memory (RAM) 403 (storage device)
Program group 404 to be loaded to the RAM 403
Storage device 405 storing therein the program group 404
Drive 406 that performs reading and writing on a storage medium 410 outside the information processing device
Communication interface 407 connecting to a communication network 411 outside the information processing device
Input/output interface 408 for performing input/output of data
Bus 409 connecting the respective constituent elements

Note that the server device 400 may use a GPU, an MPU, an FPU, a PPU, a TPU, a quantum processor, a microcontroller, or a combination thereof, instead of the CPU described above.

Moreover, the server device 400 can realize functions as the acquisition unit 421 and the determination unit 422 illustrated in FIG. 10 through acquisition and execution of the program group 404 by the CPU 401. Note that the program group 404 is stored in the storage device 405 or the ROM 402 in advance for example, and is loaded to the RAM 403 or the like by the CPU 401 as needed. The program group 404 may be provided to the CPU 401 via the communication network 411, or may be stored on a storage medium 410 in advance and read out by the drive 406 and supplied to the CPU 401.

FIG. 9 illustrates an exemplary hardware configuration of the server device 400. The hardware configuration of the server device 400 is not limited to that described above. For example, the server device 400 may be configured of part of the configuration described above, such as without the drive 406.

The acquisition unit 421 acquires, from each of a plurality of client devices, information indicating the value of a node constituting the decision tree determined based on the learning data held by the client device itself.

The determination unit 422 integrates the results acquired by the acquisition unit 421 to determine the value of the node constituting the decision tree. The determination unit 422 determines the values of the respective nodes constituting the decision tree, so that the server device 400 learns the decision tree.

As described above, the server device 400 includes the acquisition unit 421 and the determination unit 422. With this configuration, the determination unit 422 can determine the value of each node constituting the decision tree by integrating the results acquired by the acquisition unit 421. As a result, the server device 400 can perform horizontal federated learning without transmitting gradient information, and realize efficient learning.

Note that the server device 400 as described above can be realized by incorporation of a predetermined program into an information processing device such as the server device 400. Specifically, a program that is another aspect of the present invention is a program for implementing, on an information processing device such as the server device 400, processing to acquire, from a plurality of client devices, information representing a value of a node constituting the decision tree, the information being determined based on the learning data held by the client device itself, determine the value of the node constituting the decision tree by integrating the acquired results, and learn the decision tree by determining the value of each node constituting the decision tree.

Further, a learning method carried out by an information processing device such as the server device 400 is a method including, by an information processing device such as the server device 400, acquiring, from a plurality of client devices, information representing a value of a node constituting the decision tree, the information being determined based on the learning data held by the client device itself, determining the value of the node constituting the decision tree by integrating the acquired results, and learning the decision tree by determining the value of each node constituting the decision tree.

An invention of a program, a computer-readable storage medium storing thereon a program, or a learning method having the above-described configuration also exhibits the same actions and effects as those of the server device 400. Therefore, the above-described object of the present invention can also be achieved by such an invention.

Moreover, the client device 500 that transmits the value of a node, independently calculated by itself, to the server device 400 can implement the functions as the calculation unit 521 and the transmission unit 522 illustrated in FIG. 11, through acquisition and execution of a program group by the CPU or the like. Note that the hardware configuration of the client device 500 may be similar to the configuration of the server device 400 described with reference to FIG. 9.

The calculation unit 521 determines the value of a node constituting the decision tree based on the learning data held by the own device. For example, the calculation unit 521 may determine the value of each node constituting the decision tree by a method similar to that used for learning a general gradient boosting decision tree.

The transmission unit 522 transmits information representing the value of a node calculated by the calculation unit 521, to the server device 400.

As described above, the client device 500 includes the calculation unit 521 and the transmission unit 522. with this configuration, the transmission unit 522 can transmit the value of a node calculated by the calculation unit 521, to the server device 400. As a result, it is possible to perform the integration processing as described in the server device 400. Therefore, efficient learning can be realized.

Note that the client device 500 described above can be realized by incorporation of a predetermined program into an information processing device such as the client device 500. Specifically, a program that is another aspect of the present invention is a program for causing an information processing device such as the client device 500 to realize processing to determine the value of a node constituting the decision tree based on the learning data held by the own device, and transmit the information representing the calculated value of the node to the server device.

Moreover, a learning method to be carried out by an information processing device such as the client device 500 is a method including, by an information processing device such as the client device 500, determining the value of a node constituting the decision tree based on the learning data held by the own device, and transmitting the information representing the calculated value of the node to the server device.

An invention of a program, a computer-readable storage medium storing thereon a program, or a learning method having the above-described configuration also exhibits the same actions and effects as those of the client device 500. Therefore, the above-described object of the present invention can also be achieved by such an invention.

### SUPPLEMENTARY NOTES

The whole or part of the example embodiments disclosed above can be described as the following supplementary notes. Hereinafter, the outlines of the server device and the like of the present invention will be described. However, the present invention is not limited to the configurations described below.

### (Supplementary Note 1)

A server device comprising:
an acquisition unit that acquires, from each of a plurality of client devices, information representing a value of a node constituting a decision tree, the information being determined based on learning data held by an own device of each of the client devices; and
a determination unit that determines a value of the node constituting the decision tree by integrating acquired results, wherein
the decision tree is learned by determination of a value of each nodes constituting the decision tree by the determination unit.

### (Supplementary Note 2)

The server device according to supplementary note 1, wherein the
as the value of the node constituting the decision tree, the acquisition unit acquires a value including an output value of a leaf node from each of the client devices; and
the determination unit determines the value of the node that is the leaf node on the basis of at least two output values among a plurality of output values received from the client devices.

### (Supplementary Note 3)

The server device according to supplementary note 2, wherein
the determination unit determines the value of the node that is the leaf node by calculating a weighted average in which weighting is performed on a plurality of output values corresponding to a number of pieces of learning data assigned to the leaf node in each of the client devices.

### (Supplementary Note 4)

The server device according to any one of supplementary notes 1 to 3, wherein
as the value of the node constituting the decision tree, the acquisition unit acquires, from the client devices, values corresponding to a branch condition at an internal node that is a node other than the leaf node constituting the decision tree; and
the determination unit determines a value of the node that is the internal node on a basis of at least two values among a plurality of values corresponding to the branch condition received from the client devices.

### (Supplementary Note 5)

The server device according to supplementary note 4, wherein
the acquisition unit acquires feature values and thresholds as the values corresponding to the branch condition; and
the determination unit determines a feature value by performing weighted majority decision on the feature values corresponding to a number of pieces of data assigned to the internal node in each of the client devices, the feature values being values corresponding to the branch condition received from the client devices, and determines a threshold by calculating a weighted average in which weighting corresponding to the number of pieces of data is performed on the thresholds calculated by the client devices corresponding to the determined feature value.

### (Supplementary Note 6)

The server device according to supplementary note 4, wherein
as the value corresponding to the branch condition, the acquisition unit acquires a value indicating a difference in a loss function before and after branch under the branch condition, for each feature value; and
the determination unit determines the feature value serving as the branch condition on a basis of an acquired result.

### (Supplementary Note 7)

The server device according to any one of supplementary notes 1 to 6, further comprising
a checking unit that checks a stop condition in learning of the decision tree, wherein
as the value of the node constituting the decision tree, the acquisition unit acquires, from each of the client devices, one of a value including an output value of a leaf node and a value corresponding to a branch condition at an internal node that is a node other than the leaf node constituting the decision tree, according to a check result.

### (Supplementary Note 8)

A learning method performed by an information processing device, the method comprising:
acquiring, from each of a plurality of client devices, information representing a value of a node constituting a decision tree, the information being determined based on learning data held by an own device of each of the client devices;
determining a value of the node constituting the decision tree by integrating acquired results, and
learning the decision tree by determining a value of each node constituting the decision tree.

### (Supplementary Note 9)

A program for causing an information processing device to execute processing to
acquire, from each of a plurality of client devices, information representing a value of a node constituting a decision tree, the information being determined based on learning data held by an own device of each of the client devices;
determine a value of the node constituting the decision tree by integrating acquired results, and
learn the decision tree by determining a value of each node constituting the decision tree.

### (Supplementary Note 10)

A client device comprising:
a calculation unit that determines a value of a node constituting a decision tree on the basis of the learning data held by the own device; and
a transmission unit that transmits the value of the node calculated by the calculation unit to a server device.

While the present invention has been described with reference to the example embodiments described above, the present invention is not limited to the above-described embodiments. The form and details of the present invention can be changed within the scope of the present invention in various manners that can be understood by those skilled in the art.

### REFERENCE SIGNS LIST

100 learning system
200 server device
210 operation input unit
220 screen display unit
230 communication I/F unit
240 storage unit
241 received information
242 model information
243 program
250 arithmetic processing unit
251 stop condition checking unit
252 receiving unit
253 leaf node determination unit
254 branch condition determination unit
255 transmission unit
300 client device
310 operation input unit
320 screen display unit
330 communication FP unit
340 storage unit
341 learning data information
342 model information
343 program
350 arithmetic processing unit
351 receiving unit
352 calculation unit
353 transmission unit
400 server device
401 CPU
402 ROM
403 RAM
404 program group
405 storage device
406 drive
407 communication interface
408 input/output interface
409 bus
410 storage medium
411 communication network
421 acquisition unit
422 determination unit
500 client device
521 calculation unit
522 transmission unit

1. A server device comprising:
at least one memory configured to store instructions; and
at least one processor configured to execute instructions to:
acquire, from each of a plurality of client devices, information representing a value of a node constituting a decision tree, the information being determined based on learning data held by an own device of each of the client devices;
determine a value of the node constituting the decision tree by integrating acquired results, and
learn the decision tree by determining a value of each node constituting the decision tree.

2. The server device according to claim 1, wherein the at least one processor is configured to execute the instructions to:
as the value of the node constituting the decision tree, acquire a value including an output value of a leaf node from each of the client devices; and
determine the value of the node that is the leaf node on a basis of at least two output values among a plurality of output values received from the client devices.

3. The server device according to claim 2, wherein the at least one processor is configured to execute the instructions to determine the value of the node that is the leaf node by calculating a weighted average in which weighting is performed on a plurality of output values corresponding to a number of pieces of learning data assigned to the leaf node in each of the client devices.

4. The server device according to claim 1, wherein the at least one processor is configured to execute the instructions to:
as the value of the node constituting the decision tree, acquire, from the client devices, values corresponding to a branch condition at an internal node that is a node other than the leaf node constituting the decision tree; and
determine a value of the node that is the internal node on a basis of at least two values among a plurality of values corresponding to the branch condition received from the client devices.

5. The server device according to claim 4, wherein the at least one processor is configured to execute the instructions to
acquire feature values and thresholds as the values corresponding to the branch condition; and
determine a feature value by performing weighted majority decision on the feature values corresponding to a number of pieces of data assigned to the internal node in each of the client devices, the feature values being values corresponding to the branch condition received from the client devices, and determine a threshold by calculating a weighted average in which weighting corresponding to the number of pieces of data is performed on the thresholds calculated by the client devices corresponding to the determined feature value.

6. The server device according to claim 4, wherein the at least one processor is configured to execute the instructions to
as the value corresponding to the branch condition, acquire a value indicating a difference in a loss function before and after branch under the branch condition, for each feature value; and
determine the feature value serving as the branch condition on a basis of an acquired result.

7. The server device according to claim 1, wherein the at least one processor is configured to execute the instructions to
check a stop condition in learning of the decision tree; and
as the value of the node constituting the decision tree, acquire, from each of the client devices, one of a value including an output value of a leaf node and a value corresponding to a branch condition at an internal node that is a node other than the leaf node constituting the decision tree, according to a check result.

8. A learning method performed by an information processing device, the method comprising:
acquiring, from each of a plurality of client devices, information representing a value of a node constituting a decision tree, the information being determined based on learning data held by an own device of each of the client devices;
determining a value of the node constituting the decision tree by integrating acquired results, and
learning the decision tree by determining a value of each node constituting the decision tree.

9. A non-transitory computer-readable medium storing thereon a program for causing an information processing device to execute processing to
acquire, from each of a plurality of client devices, information representing a value of a node constituting a decision tree, the information being determined based on learning data held by an own device of each of the client devices;
determine a value of the node constituting the decision tree by integrating acquired results, and
learn the decision tree by determining a value of each node constituting the decision tree.
